(19) United States
(12) Patent Application Publication
(10) Pub. No.: US 2010/0324774 A1
(43) Pub. Date: Dec. 23, 2010

(54) VEHICLE OCCUPANT SAFETY SYSTEM AND METHOD INCLUDING A SEAT-BACK ACCELERATION SENSOR

(75) Inventors: Essam E. Bouni, Novi, MI (US); Joachim Schmidt, Plymouth, MI (US)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/819,063

(22) Filed: Jun. 18, 2010

Related U.S. Application Data
(60) Provisional application No. 61/218,674, filed on Jun. 19, 2009.

(51) Int. Cl. B60R 21/0132

(52) U.S. Cl. 701/29

(57) ABSTRACT

Systems and methods for determining conditions of a seat within a vehicle and modifying the operation of at least one safety system or device in response to the conditions of the seat. The system includes a sensor module located in a seat-back of the seat, a control module, and at least one safety system. The sensor module includes one or more accelerations sensors for measuring the acceleration of the seat along first, second, and third axes with respect to the vehicle (e.g., longitudinal, transverse, and vertical directions with respect to the vehicle). The signals generated by the acceleration sensor are sent to the control module, which uses the signals to determine a plurality of conditions of the first seat. The conditions of the seat include, for example, a seat-back tilt angle, a seat-shock (e.g., from a collision), vehicle dynamics (e.g., vehicle acceleration and velocity in multiple directions), and a vehicle rollover condition. Based on the seat conditions, the control module generates one or more control signals to compensate, enable, disable, or otherwise modify the safety system.

### RELATED APPLICATIONS

This application claims the benefit of previously-filed, co-pending U.S. Provisional Patent Application No. 61/218,674, filed Jun. 19, 2009, the entire content of which is hereby incorporated by reference.

### BACKGROUND

This invention relates to systems and methods for determining conditions of a seat within a vehicle, and modifying the operation of one or more vehicle safety systems based on the determined seat conditions.

Modern vehicles include a plurality of sensors for sensing a variety of conditions of a vehicle. For example, wheel speed sensors, yaw rate sensors, steering angle sensors, and the like are used by electronic stability control (“ESC”) systems to improve vehicle stability. Vehicles also include sensors for improving the safety of a vehicle. For example, front and rear impact sensors and occupant weight sensors are used to classify vehicle occupants and control the deployment of airbags and other occupant restraints.

### SUMMARY

Although embodiments of the invention are described below with respect to a vehicle such as a passenger car, in other embodiments, the seat-back sensor module is installed in other vehicles, such as, aircraft, trains, trucks, buses, boats, all-terrain vehicles, snowmobiles, and the like. Additionally, although a seat-back sensor module is described below primarily with respect to the passenger seat of the vehicle, the seat-back sensor module may be included in other seats and seat types within the vehicle (e.g., a driver's seat, one or more back seats, a bench seat, a bucket seat, etc.) to modify the operation of a vehicle safety system (e.g., an airbag deployment system, seatbelt pre-tensioning system, or the like) with respect to each seat based on, among other things, a seat-tilt angle, seat acceleration values, seat velocity values, and seat shock values.

Embodiments of the invention relate to a system for determining a variety of conditions of a seat within a vehicle, and modifying the operation of at least one vehicle safety system in response to the conditions of the seat. The system includes a sensor module located in a seat-back of the seat, a control module, and at least one vehicle safety system. The sensor module includes a plurality of sensors for detecting characteristics of the seat. The sensors include, for example, one or more accelerations sensors. In one embodiment, the sensors include a three-axis accelerometer which measures the acceleration of the seat along first, second, and third axes with respect to the vehicle (e.g., longitudinal, transverse, and vertical directions with respect to the vehicle). The signals generated by the acceleration sensor are sent to the control module which uses the signals to determine a plurality of conditions of the first seat, such as, for example, a seat-back tilt angle, a seat-shock (e.g., from a collision), vehicle dynamics (e.g., vehicle acceleration and velocity in multiple directions), and a vehicle rollover condition. Based on the seat conditions, the control module generates one or more control signals to compensate, enable, disable, or otherwise modify the vehicle safety system. In some embodiments, the vehicle safety system is an airbag control system or a seatbelt pre-tensioning system. One or more of the airbags within the vehicle are selectively activated or deactivated, or the release time of the airbag is modified to prevent an occupant from being seriously injured during a collision.

In one embodiment, the invention provides a system for modifying the operation of one or more vehicle safety systems. The system includes a sensor module, a control module, and a vehicle safety module. The sensor module is located within a first seat of a vehicle, includes at least one acceleration sensor, and generates one or more signals indicative of at least one condition of the first seat. The control module is connected to the sensor module, receives the one or more signals from the sensor module, and generates at least one control signal in response to the at least one condition of the first seat. The vehicle safety system is connected to the control module, receives the at least one control signal, and modifies at least one safety parameter based on the control signal.

In another embodiment, the invention provides a system for modifying the operation of one or more safety systems in a vehicle. The system includes a sensor module, a control module, and a safety system. The sensor module is located or positioned within a seat of the vehicle and includes at least one acceleration sensor. The sensor module is configured to generate an acceleration signal indicative of a condition of the seat. The control module is connected to the sensor module, and is configured to receive the acceleration signal from the sensor module and generate a control signal in response to the acceleration signal. The safety system is connected to the control module and configured to receive the control signal and modify a safety parameter based on the control signal.

In another embodiment, the invention provides a method of modifying the operation of one or more safety systems in a vehicle. The method includes generating an acceleration signal indicative of a condition of a seat, receiving the acceleration signal at a control module, and generating a control signal in response to the acceleration signal. The method also includes receiving the control signal at a safety system and modifying a safety parameter based on the control signal.

In another embodiment, the invention provides a system for controlling the operation of a safety device within a vehicle. The system includes an acceleration sensor, a control module, and a safety system. The acceleration sensor is located within a seat-back of a vehicle seat, and is configured to generate a signal indicative of an acceleration of the seat along an axis. The control module is configured to receive the signal from the acceleration sensor and generate a control signal based on the acceleration of the seat. The safety system is configured to receive the control signal and modify a control parameter of the safety device based on the acceleration of the seat.

Other aspects of the invention will become apparent by consideration of the detailed description and accompanying drawings.

### BRIEF DESCRIPTION OF THE DRAWINGS

FIG. 1 illustrates a vehicle that includes a plurality of sensors connected in a vehicle control system.

FIG. 2 is a diagram of a vehicle control system according to an embodiment of the invention.

FIG. 3 illustrates an occupant weight estimating system according to an embodiment of the invention.

FIG. 4 illustrates a rear view of a vehicle seat which includes a seat-back sensor module.

FIG. 5 illustrates a side view of the vehicle seat of FIG. 4.

FIGS. 6 and 7 are a process for modifying a vehicle safety system based on signals from a seat-back sensor module.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Embodiments of the invention described herein relate to systems and methods for determining a variety of conditions of one or more seats within a vehicle, and modifying the operation of at least one vehicle safety system (e.g., an airbag deployment system, a seatbelt pre-tensioning system, or the like) in response to the conditions of the seat. The system includes a sensor module located in a seat-back of a seat, a control module, and the at least one vehicle safety system. The sensor module includes a plurality of sensors such as a three-axis accelerometer which measures the acceleration of the seat along first, second, and third axes with respect to the vehicle (e.g., longitudinal, transverse, and vertical accelerations). The signals generated by the acceleration sensor are sent to the control module which uses the signals to determine a plurality of conditions of the seat including, for example, a seat-back tilt angle, a seat-shock (e.g., from a collision), vehicle dynamics (e.g., vehicle acceleration and velocity in multiple directions), and a vehicle rollover condition. Based on the seat conditions, the control module generates one or more control signals to compensate, enable, disable, or otherwise modify at least one vehicle safety system. For example, one or more airbags within the vehicle are selectively activated or deactivated, or an airbag release time is modified to prevent an occupant from being seriously injured during a collision.

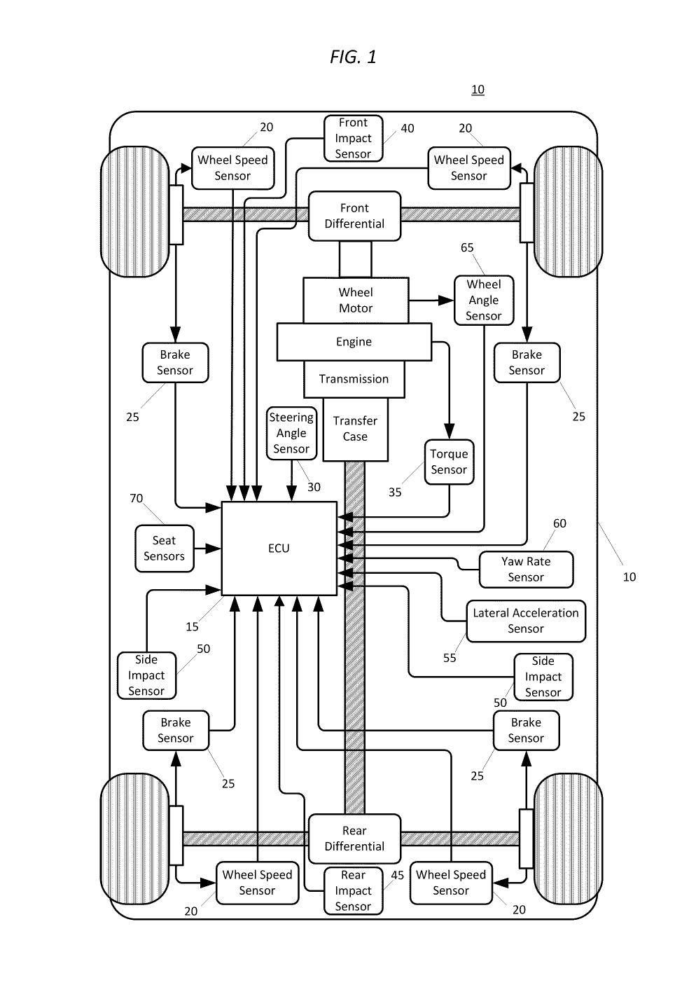

FIG. 1 illustrates a vehicle 10 that includes a plurality of sensors. The sensors are connected to, for example, an electronic control unit (“ECU”) 15 which uses the sensor signals to determine a plurality of conditions of the vehicle 10. The sensors include wheel speed sensors 20, brake sensors 25, a steering angle sensor (“SAS”) 30, a torque sensor 35, a front impact sensor 40, a rear impact sensor 45, side impact sensors 50, a lateral acceleration sensor 55, a yaw rate sensor 60, a wheel angle sensor 65, and seat sensors or seat-back sensors 70. The seat sensors include, for example, occupant weight sensors (e.g., i-Bolt™ sensors, strain gauges, or the like) and one or more seat-back acceleration sensors. Each of the vehicle sensors is used by one or more vehicle control systems or subsystems, such as an electronic stability control (“ESC”) system, a vehicle safety system, or a traction control system.

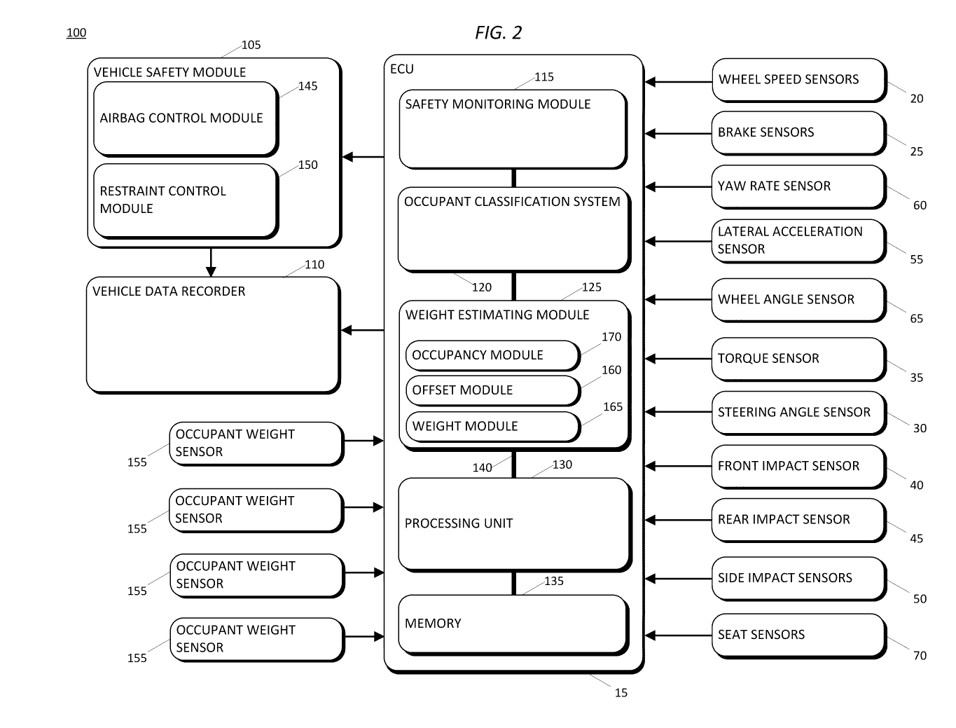

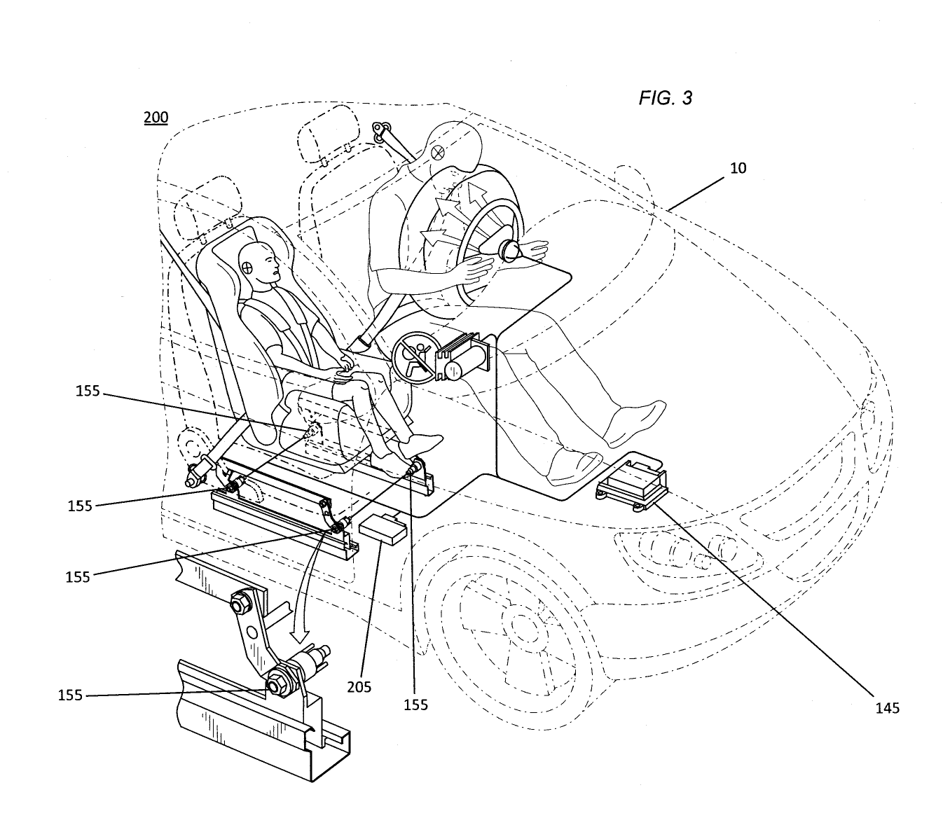

FIG. 2 is a diagram of a vehicle control system 100 that includes the ECU 15, a vehicle safety system 105, and a vehicle data recorder 110. The ECU 15 includes a safety monitoring module 115, an occupant classification system 120, a weight estimating module 125, a processing unit 130, a memory 135, and a bus 140. In some embodiments, the occupant classification system 120 and weight estimating module 125 are separate from the ECU 15, as illustrated in FIG. 3. The bus 140 connects various components of the ECU 15 including the memory 135 to the processing unit 130. The memory 135 includes, for example, read only memory (“ROM”), random access memory (“RAM”), and/or electrically erasable programmable read only memory (“EEPROM”). The ECU 15 also includes an input/output system that includes routines for transferring information between components within the ECU 15 and the various sensors and modules connected to the ECU 15. Software included in the ECU 15 is stored in, for example, the EEPROM. The software includes, for example, firmware applications and other executable instructions. The ECU 15 receives signals from the vehicle sensors over, for example, a controller-area network (“CAN”) bus. The ECU conditions and processes the signals, and transmits the processed and conditioned signals to the vehicle safety system 105, the vehicle data recorder 110, or another vehicle control system over the CAN bus. The vehicle safety system 105 receives the processed and conditioned signals and modifies its operation accordingly. In other embodiments, the ECU 15 includes additional, fewer, or different components, or is connected to additional vehicle subsystems, such as a traction control system or an ESC system.

The safety monitoring module 115 receives signals from vehicle sensors such as the seat-back sensors 70, the impact sensors 40, 45, and 50, the wheel speed sensors 20, the yaw rate sensor 60, and the lateral acceleration sensor 55. As described in greater detail below, the safety monitoring module 115 uses these and other sensors to generate one or more control signals to control, among other things, the activation of airbags, deactivation of airbags, seatbelt pre-tensioning, and/or vehicle occupant classification. The safety monitoring module 115 sends the control signals to the vehicle safety system 105 which interprets the control signals and applies them to, for example, an airbag control module 145 and a restraint control module 150 as necessary. As an illustrative example, the vehicle safety system 105 receives a control signal from the safety monitoring module 115 which instructs the vehicle safety system 105 to selectively activate and/or deactivate various airbags (e.g., side airbags, knee airbags, front airbags, etc.) based on dynamic conditions of the vehicle (e.g., velocity or acceleration), a condition of a seat (e.g., seat reclined, seat upright, lateral acceleration, etc.), and vehicle occupant classification.

An occupant weight sensing or estimating system includes, for example, one or more occupant weight sensors 155, the weight estimating module 125, and the occupant classification system 120. The signals produced by the weight sensors 155 indicate the force exerted on the seat. The force exerted on the seat includes those forces due to an occupant or other object located on the seat, vehicle dynamics, intrinsic loads, and other forces. Vehicle dynamics depend on a travel surface, vehicle speed, vehicle acceleration, and the physical characteristics of the vehicle (such as, tire inflation, tilt, and suspension). Intrinsic loads are generally a result of tolerance deviations in the sensors, and represent energy stored in the structure of the seat. The other vertical forces are due to gravity, such as the self-mass of the seat located above the sensors. Additionally, the force on the seat may include intrinsic forces (those not due to the occupant), such as those caused by seatbelts under tension and objects wedged in the seat, and other objects or occupants leaning on the seat.

The signals from the occupant weight sensors 155 are sent to the occupant weight estimating module 125 in the ECU 15 which includes, for example, an offset module 160, a weight module 165, and an occupancy module 170. In one embodiment, the occupancy module 170, weight module 165, and the offset module 160 work together to determine the weight of the occupant when the seat is not empty. Using the signals received from the weight sensors 155, the occupancy module 170 determines whether the seat is empty. If the seat is empty, the occupancy module 170 communicates a signal to the offset module 160 instructing the offset module 160 to determine an offset of the weight sensors 155. The offset module 160 determines the offset using the signals from the weight sensors 155 and communicates the offset to the weight module 165. If the seat is not empty, the occupancy module 170 instructs the weight module 165 to determine the weight of an occupant according to an offset determined by the offset module 160 the last time the seat was empty. Alternatively, the occupancy module 170 determines that the occupancy of the seat is unknown. In this case, the occupancy module 170 instructs the weight module 165 to determine the weight of the occupant without correcting for offset errors. The weight estimating module 125 then generates a weight estimate based on the signals from the weight sensors 155.

The weight estimate is communicated to the occupant classification system 120 which classifies the occupant based on the estimated weight, and generates a occupant classification signal which is sent to the safety monitoring module 115. The safety monitoring module 115 then generates one or more control signals for controlling the vehicle safety system 105. For example, if the occupant classification system 120 classifies an occupant as a child, the safety monitoring module 115 produces a control signal that instructs the airbag control module 145 to deploy the airbag with a lower deployment force than would be used if the occupant were classified as an adult. Alternatively, if the occupant classification system 120 classifies an occupant as an infant, the safety monitoring module 115 produces a control signal that instructs the airbag control module 145 to disable the airbag to prevent it from being deployed.

FIG. 3 illustrates an airbag system which is installed in the vehicle 10. The airbag system includes the weight sensors 155 connected to a control unit 205 that includes the occupant classification system 120 and the weight estimating module 125. Collectively, these components form an occupant weight estimating and classification system 200. Alternatively and as shown in FIG. 2, the weight sensors 155 are connected directly to the ECU 15 and the occupant classification system 120 and the weight estimating module 125 are included in the ECU 15. The weight sensors 155 are generally located under one or more of the seats in the vehicle 10. A type of sensor known as an intelligent bolt or i-Bolt™ sensor (manufactured by Robert Bosch GmbH) is shown, but other force sensors or weight sensors, such as a strain gauge system, an occupant classification (“OC”) sensor mat, a capacitive weight measurement system, or a passenger occupant detection (“POD”) system can be used in other embodiments of the invention. Although four sensors are shown, other embodiments of the invention include more or fewer sensors located in the same or different locations within the seat.

As shown in FIG. 3, the occupant weight estimating and classification system 200 is installed in the front passenger seat of the vehicle 10. In other embodiments, the occupant weight estimating and classification system 200 is installed in any seat of the vehicle 10. With respect to the driver's seat, it is assumed that the driver is at least 16 years old and does not require modification of the airbag deployment based on an estimated weight. Accordingly, the occupant weight estimating and classification system 200 is omitted from the driver's seat. Alternatively, because some drivers do require modification of the airbag deployment, the occupant weight estimating and classification system 200 is also installed in the driver's seat. The weight sensors are generally in communication with the weight estimating module 125 and the occupant classification system 120 which are, in turn, connected to the safety monitoring module. The safety monitoring module is connected to the vehicle safety system 105 that includes the airbag control module 145. In some embodiments, the airbag control module 145 is preprogrammed with properties of airbag deployment, such as force and timing of deployment, and the circumstances required for deployment.

Airbags are deployed using, for example, two-stage initiators (i.e., small explosive charges which are used to deploy and inflate an airbag) for both passenger and driver seats in a vehicle 10. A first initiator or first-stage initiator provides the initial deployment and inflation of the airbag. The first initiator uses a smaller force than, for example, single-stage initiators, which have been known to cause injuries to vehicle occupants during collisions. The second initiator uses a smaller force than the first initiator to maintain the inflation of the airbag. The first and second initiators are activated with a predetermined time delay between them, such as 100 ms. The time delay between the activation of the first and second initiators is modified by the safety monitoring module and the vehicle safety system 105 based on signals received from the seat-back sensor module (e.g., seat-back tilt angle) and vehicle occupant classification.

The signals received from the weight sensors 155, which are subsequently used to estimate an occupant weight, classify the occupant, and control, for example, airbag deployment are subject to offsets and/or signal fluctuations which result from the motion of the vehicle and the position of the occupant in the seat. These factors cause the sensors to make incorrect measurements and potentially result in an incorrect occupant weight estimation and classification, which is particularly dangerous during a vehicle event such as a collision or accident. As such, signals from the seat-back sensor module are used in combination with the occupant weight estimate and classification to control the operation of the vehicle safety system 105. The signals from the seat-back sensor module are also used to compensate the weight sensors 155 and the occupant weight estimating module 125, or prevent the occupant classification system 120 from incorrectly classifying an occupant (or incorrectly updating an occupant classification).

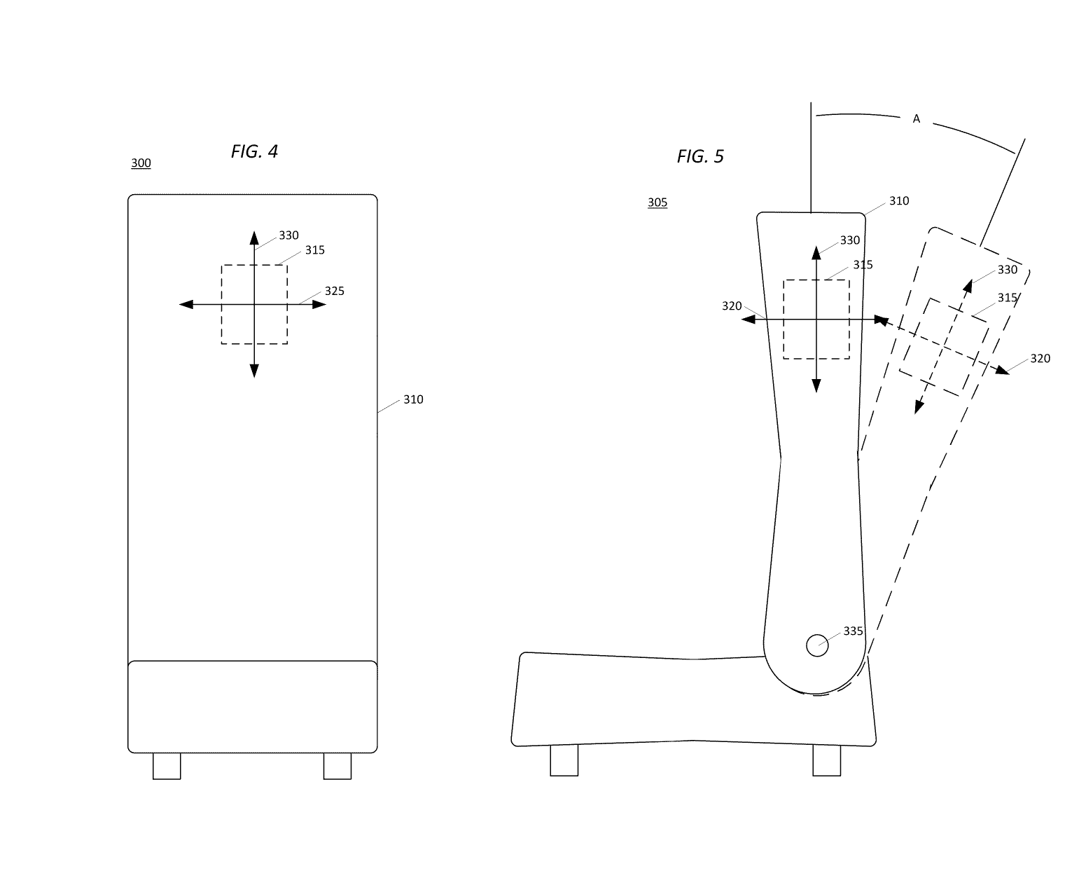

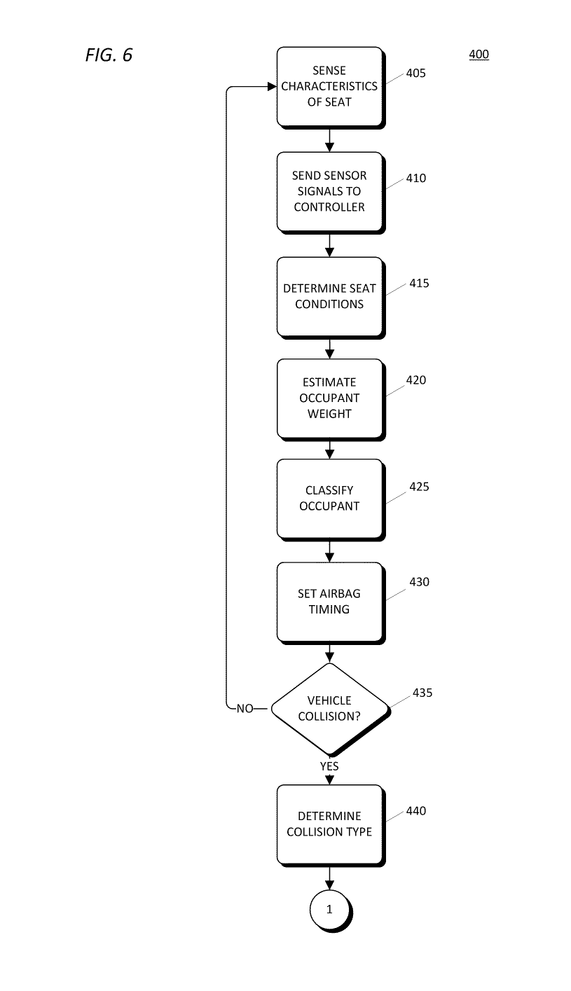

FIGS. 4 and 5 illustrate rear and side views 300 and 305, respectively, of a vehicle seat 310 that includes a seat-back sensor module 315. The seat-back sensor module 315 includes, for example, a three-axis accelerometer for measuring the acceleration of the seat along longitudinal 320, transverse 325, and vertical 330 axes with respect to the vehicle 10 (e.g., along the x, y, and z axes, respectively). The signals from the seat-back sensor module 315 are also used to calculate vehicle velocities in the longitudinal, transverse, and vertical directions. For example, the seat 310 is configured to recline by an angle, A, with respect to a pivot point 335. The acceleration sensor is able to determine the angle (from vertical) for which the seat-back is reclined. As the seat-back is reclined, the value for the vertical acceleration sensed by the acceleration sensor along a z-axis 330 and the acceleration sensed by the acceleration sensor along the x-axis 320 are each offset from a steady-state value (e.g., offset from 0.0 m/s²). The change in acceleration sensor readings along each axis is, for example, proportional to the acceleration due to gravity, g, and the sine of the angle, as shown below in EQN. 1.

Δg=g₂−g=g·sin(A) EQN. 1

Accordingly, the angle, A, of seat declination is calculated by solving EQN. 1 for the angle, A, as shown in EQN. 2.

$$A = {sin}^{- 1} ( \frac{( {g}_{2} - g )}{g} ) \qquad EQN . 2$$

In other embodiments, alternative techniques for determining a seat-back tilt angle are used, such as using a different trigonometric function (e.g., a cosine function) or a combination of trigonometric functions (e.g., sine and cosine functions).

The seat-back tilt angle allows the ECU 15 to determine the location or approximate location of an occupant with respect to other parts of the vehicle 10. For example, if a seat-back tilt angle is approximately 180° (i.e., flat or as far back as the seat reclines), the occupant's head is near the back seat and is near a deployment zone for a rear-side curtain airbag. Depending on other conditions of the vehicle (as described below), it is possible for a vehicle occupant to be pinned behind a side-curtain airbag, for the side curtain airbag to impact the occupant in the face or head, or for the occupant to impact a front airbag after it has already deflated (or partially deflated). In such a situation, the ECU 15 instructs the vehicle safety system 105 to disable the rear side curtain airbag to avoid injury to the occupant or adjust the timing of the frontal airbag such that it is not deflated when the occupant impacts it. In other embodiments, the ECU 15 is able to limit the seat-back tilt angle to prevent an occupant from positioning the seat such that they are susceptible to serious injury during a collision. In the above described example, the seat-tilt angle may be limited to, for example, 60° from the vertical axis to prevent the side-curtain airbag from being able to injure the occupant. Similarly, the occupant classification system 120 or the occupant weight estimating module 125 described above are able to classify occupants and determine if a child safety chair is in the seat. If the ECU 15 determines that a child safety chair is present, the seat-tilt angle is limited based on signals from the seat-back sensor module 315 to prevent the child safety seat from being positioned in a potentially harmful manner with respect to seat belts and airbags.

The seat-back sensor module 315 is also used to determine seat-shock resulting from, for example, the motion of the vehicle (e.g., on a bumpy surface) or a collision. Seat-shock is determined using the signals from the acceleration sensors. For example, the acceleration signals from the seat-back sensor module 315 are compared to seat-shock threshold values to identify implausible accelerations values or offsets which are likely or able to cause the occupant classification system 120 to incorrectly classify an occupant. The seat-shock threshold values have either predetermined values which are set in a factory, or have values based on current driving conditions (i.e., the seat-shock threshold values are determined based on signals from vehicle sensors such as the wheel speed sensors 20, the SAS 30, etc.). In the event of an acceleration value exceeding a seat-shock threshold value, the safety monitoring module 115 prevents the occupant classification system 120 from updating an occupant classification. For example, when traveling over bumpy terrain or making a hard turn to the right or left, offsets appear on the output acceleration signals from the seat-back sensor module 315. These offsets are indicative of a change in the occupant weight estimated by the occupant weight estimating module 125. In some instances, the changes in the estimated occupant weight are directly proportional to the acceleration sensor offsets. When this occurs, the estimated weight is incorrect and the occupant classification system is susceptible to incorrectly classifying an occupant. If the occupant is incorrectly classified, the airbags and seatbelt controls may be set in a manner which is harmful to the occupant. Accordingly, by preventing the occupant classification system 120 from updating an occupant classification when a seat-shock threshold is exceeded, the vehicle safety system 105 continues to operate properly. In some embodiments, whenever a seat-shock threshold is exceeded, a signal is sent to the vehicle data recorder 110 to record an indication of the same.

The ECU 15 also uses the signals from the seat-back sensor module 315 to determine a seat-shock direction. For example, a seat-shock toward the rear of the vehicle is sometimes indicative of a rear-impact collision, and a seat-shock toward the front of the vehicle is sometimes indicative of a front-impact collision or hard braking. A seat-shock in the vertical direction (i.e., along the z-axis) is indicative of bumpy terrain. The magnitude and direction of a seat-shock is used in combination to both identify conditions or events for which the occupant classification system 120 is to be prevented from updating a classification, as well as to determine when the occupant classification system 120 is able to once again classify an occupant. In some embodiments, information related to both the magnitude and direction of a seat-shock is sent to the vehicle data recorder 110.

The signals from the seat-back sensor module 315 are also used to determine vehicle or seat velocities in multiple directions. For example, the ECU 15 extrapolates an equation (or equations) for the accelerations signals received from the seat-back sensor module 315, and integrates the equation with respect to time to determine one or more vehicle velocities. In some embodiments, velocities for the vehicle are calculated in the longitudinal, transverse, and vertical directions with respect to the vehicle 10. The values for vehicle velocity based on the signals from the seat-back sensor module 315 are compared to signals from, for example, the wheel speed sensors 20, the lateral acceleration sensor 55 (i.e., the integral of the output from the lateral acceleration sensor) to determine if seat velocities are implausible with respect to the motion of the vehicle (e.g., there are differences between the two that are greater than one or more seat velocity threshold values).

The seat-back sensor module 315 is also able to estimate a vehicle turning angle. For example, when the vehicle is turning, the transverse acceleration sensed by the seat-back sensor module 315 is equal (or approximately equal) to the centripetal acceleration of the vehicle. Using this transverse acceleration and vehicle speed (determined by, for example, the wheel speed sensors), a radius for a turning arc and subsequently a turning angle are calculated. For example, as the vehicle turns, it travels through an arc length, L, at a speed, v, and with a centripetal acceleration, a. A radius, R, is calculated from the acceleration and the velocity. The length, L, and the radius, R, are then used in EQN. 3 to calculate a turning angle, θ.

$$θ = \frac{L}{R} \qquad EQN . 3$$

When the vehicle is turning, the occupant's weight is shifted in the seat. For example, when turning to the right, the occupant's weight is shifted back and to the left. This weight shift alters the weight estimate from the occupant weight estimating module 125 and, in turn, may change the classification of the occupant.

The signals from the seat-back sensor module 315 are used to determine one or more offset values for compensating the weight sensors 155 and the occupant weight estimating module 125 and preventing the occupant classification system 120 from incorrectly classifying an occupant. For example, as described above, the seat-shock is compared to a seat-shock threshold value. If the seat-shock is greater than the seat-shock threshold value, the occupant classification system 120 may incorrectly classify the occupant due to the changes in the output signals from the weight sensors 155. In such a situation, the safety monitoring module 115 prevents the occupant classification system 120 from updating the occupant classification, and ultimately from modifying the operation of the vehicle safety system 105. Similar prevention techniques are used to account for changes in estimated weight which result from the vehicle turning, the seat-back tilt angle, and the like. In one embodiment, the safety monitoring module 115 prevents the occupant classification system 120 from updating an occupant classification until the signals received from the seat-back sensor module 315 are indicative of normal driving conditions. In order to determine whether the signals are indicative of normal driving conditions, the calculated vehicle accelerations, velocities, turning angles, etc. are compared to corresponding values determined from other vehicle sensors such as the SAS 30, wheel speed sensors 20, and the like. As an illustrative example, if the vehicle 10 is traveling over a bumpy road, the signals from the seat-back sensor module 315 show large variations in vertical acceleration, seat-shock, vehicle velocity (in the vertical direction), and seat-shock direction, which are likely to cause the vehicle to incorrectly classify the occupant. The safety monitoring module 115 prevents the occupant classification system 120 from updating an occupant classification until these values have returned to normal values (when compared to other vehicle sensors). Whether the delay in occupant classification is short or long, the safety monitoring module 115 uses the most recent occupant classification to control the vehicle safety system 105 until the vehicle settles, and the signals from the seat-back sensor module are again within acceptable offset limits (e.g., are lower than each threshold value which causes the safety monitoring module 115 to prevent the occupant classification system 120 from updating the occupant's classification).

Additionally, in some embodiments, the safety monitoring module 115 within the ECU 15 classifies a crash or collision based on signals from the impact sensors 40, 45, and 50, seat-back sensor module 315, and other vehicle sensors. The crash or collision is classified as, for example, a front-impact collision, a side-impact collision, a rear-impact collision, or a rollover crash. The safety monitoring module 115 then modifies the operation of the vehicle safety system 105 based on a crash or collision type.

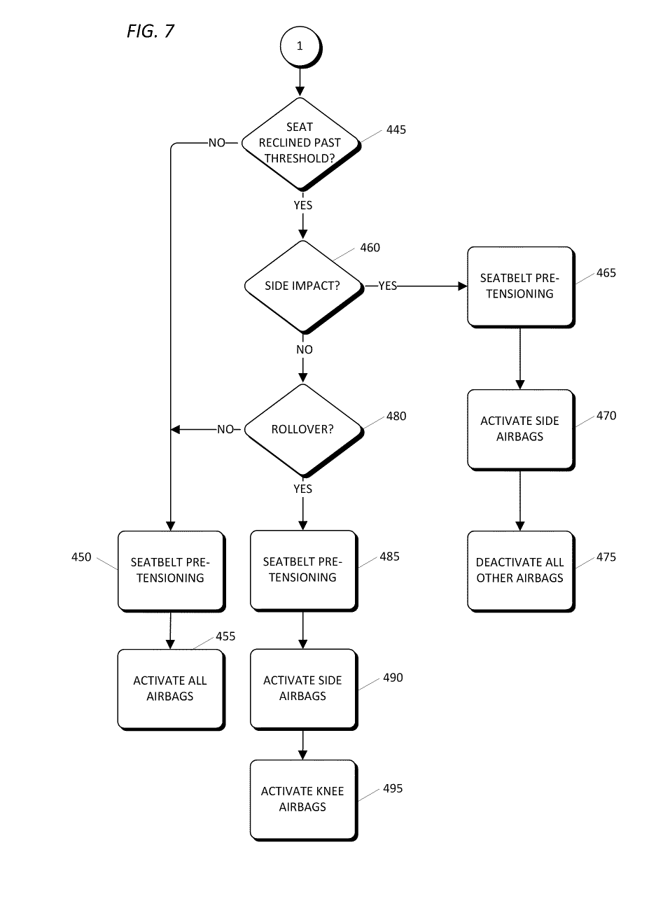

For example, based on the information determined from the seat-back sensor module 315 described above, and the classification of the occupant based on weight, the operation of the vehicle safety system 105 is modified to limit an occupant's risk of injury during a collision or accident. For example, FIGS. 6 and 7 illustrate a process for modifying the control of the vehicle safety system 105 based on the signals from the seat-back sensor module 315. The seat-back sensor module 315 described above senses a plurality of characteristics of the seat, such as accelerations in three directions, seat-back tilt angle, etc. (step 405) and generates a plurality of corresponding sensor signals. The signals from the seat-back sensor module 315 are sent to one or more controllers, such as the ECU 15 (step 410). The ECU 15 then determines a plurality of seat conditions based on the plurality of sensor signals from seat-back sensor module 315 (step 415). For example, the ECU 15 determines acceleration values for the seat along three axes (e.g., longitudinal, lateral, and vertical) with respect to the vehicle 10, vehicle lateral velocity, vehicle longitudinal velocity, seat-back tilt angle, occupant position, etc., as described above. Following step 415, the occupant's weight is estimated (step 420) and the occupant is subsequently classified (step 425), as described above. Based on the occupant classification and the information from the seat-back sensor module 315, one or more operational controls are set in the vehicle safety system 105 (step 430). The operational controls include, for example, airbag initiator timing and deployment force settings.

The ECU then determines whether the vehicle has been or is going to be involved in a collision (step 435). For example, the front, rear, and side impact sensors are used to detect a vehicle impact or collision. Additionally or alternatively, sensors such as front and rear proximity sensors are used to predict a collision based on the rate and proximity of an object which is approaching the vehicle. If no collision is detected, steps 405-435 repeat based on newly acquired sensor signals. Although FIG. 6 illustrates steps 405-435 sequentially and only repeating when no collision is detected, in other embodiments, the sensor module continuously generates sensor signals related to characteristics of the seat and the ECU continuously determines the plurality of seat conditions.

If a collision is detected (or predicted), the safety monitoring module 115 uses the signals from the seat-back sensor module 315, the impact sensors 40, 45, and 50, and additional sensors (e.g., lateral acceleration sensor 55) to determine a collision type (step 440). Collision types include, for example, front-impact collisions, rear-impact collisions, side-impact collisions, and a vehicle rollover crash. Based on the collision type and seat-tilt angle, the safety monitoring module 115 is able to determine the safety precautions necessary to limit the danger or potential for injury of the vehicle occupant. For example, the safety monitoring module 115 generates control signals which selectively activate airbags and pre-tension seatbelts. In some embodiments, seatbelt pre-tensioning activation is based on a collision type, but the force with which the seatbelt is pre-tensioned is based on the classification of the occupant determined in step 425. However, in addition to determining a collision type, the safety monitoring module 115 also considers the position of an occupant within the vehicle before determining which airbags to activate or seat belts to pre-tension. For example, the safety monitoring module 115 determines whether a seat is reclined past a seat-tilt angle threshold value (step 445). The seat-tilt threshold value is, for example, a 45° angle with the z-axis 330 (i.e., the vertical axis). If the seat-tilt angle is less than the seat-tilt threshold value, the safety monitoring module 115 determines that the occupant's position is such that seat-belt pre-tensioning (step 450) and activating all of the airbags (e.g., front, side, knee, etc.) (step 455) provides the lowest risk of injury for the occupant. If the seat-tilt angle is greater than the seat-tilt threshold value, the safety monitoring module 115 checks for a side-impact collision.

If the collision type determined in step 460 is a side-impact collision, the safety monitoring module 115 generates a control signal which is sent to the vehicle safety system 105 indicating that passenger seatbelt pre-tensioning is required (step 465), the side airbags are to be activated (step 470), and all other airbags are to be deactivated (step 475). If the collision type is not a side-impact collision type, the safety monitoring module 115 checks for a vehicle rollover (step 480). If the vehicle is experiencing a rollover, the safety monitoring module 115 generates a control signal which is sent to the vehicle safety system which indicates that the passenger seatbelt pre-tensioning is required (step 485), that the side airbags are to be activated (step 490), and that the knee airbags are to be activated (step 495). In some embodiments, if a vehicle rollover is detected or predicted, or if the lateral acceleration of the seat indicates that the vehicle is on its side, the ECU 15 generates a control signal which is sent to a fuel system controller or fuel system ECU to cut off the flow of fuel (e.g., gasoline, diesel, hydrogen, ethanol, or the like) to an engine or other vehicle power plant. The control signal is sent from the ECU 15 to the fuel system controller via the CAN bus, or the fuel system controller receives the fuel cutoff control signal via a hardwired connection to the ECU 15. Additionally or alternatively, the ECU 15 generates a control signal which is sent to a vehicle power distribution system, such as a power distribution system in an electric vehicle, via the CAN bus or a hardwired connection to inhibit the flow of electricity to a motor. If the vehicle is not in a rollover, the safety monitoring module 115 determines that the occupant's position is such that seatbelt pre-tensioning (step 450) and activation of all of the airbags (e.g., front, side, knee, etc.) (step 455) provides the lowest risk of injury for the occupant.

As an illustrative example, the seat-back sensor module 315 is used to determine if the vehicle is experiencing a rollover (or potential rollover) situation. For example, during a soil- or curb-tripped rollover event, the vehicle experiences a lateral deceleration when it contacts the soil or curb (before the actual rollover occurs). The lateral deceleration often causes the vehicle occupants to move rapidly into positions within the vehicle that may be unsafe, and the occupant weight estimating and classification system 200 may incorrectly estimate an occupant weight or incorrectly classify the occupant based on occupants shift in position. In such an instance, the operation of restraint devices must be modified to be deployed before the vehicle occupants are moved out of a seating position and into other, and possibly unsafe, positions within the vehicle 10. As such, if restraint devices are deployed during a rollover with incorrect timing (or force) based on an incorrect occupant weight estimate or occupant classification, the occupants may have already moved to positions where activation of the restraint devices is ineffective or injurious. Accordingly, the ECU 15 must be able to properly classify the occupant and properly identify the location of the occupant in order to deploy the restraint devices safely before the occupants have moved into positions within the vehicle that may be unsafe.

In some embodiments, a threshold value, such as 10 degrees, is used to identify a rollover event. However, depending on the position of the occupant in the seat (e.g., seat-tilt angle) restraint devices often need to be deployed before the roll angle reaches 10 degrees to prevent injury to the occupant. Activating restraint devices with incorrect timing can be injurious to the occupant. For example, deploying restraint devices such as an inflatable side-curtain airbag later than necessary can result in trapping an occupant between a window and the airbag. To compensate for the delay which results from, for example, the seat-back tilt angle, other information such as lateral speed of the seat is used to predict rollover behavior. The lateral speed of the seat is determined based on lateral acceleration signals from the seat-back sensor module 315, as described above. The safety monitoring module 115 generates a vehicle safety system control signal based on the determined lateral speed and the critical angle that modifies the deployment time of one or more airbags, deployment force of one or more airbags, and/or seatbelt pre-tensioning of one or more seatbelts in response.

The signals and information from the vehicle sensors, the ECU 15, and the vehicle safety system 105 are sent to the vehicle data recorder 110 over the CAN bus. For example, collision information, sensor offset information, airbag force and timing information, and occupant classification information is stored in an internal memory of the vehicle data recorder 110 for later analysis by, for example, an insurance company to assist in determining which driver may be at fault in a collision, and/or if a seat or sensor is defective. Similarly, other information related to the signals from the seat-back module, such as seat-tilt angle, is also stored in the vehicle data recorder 110. In some embodiments, the vehicle data recorder 110 records sensor information, offset information, vehicle safety system control signals, and the like each time a threshold value related to the seat-back sensor module 315 signals is exceeded, and the safety monitoring module 115 prevents the occupant classification system 120 from updating an occupant classification.

Thus, the invention provides, among other things, a system for determining a variety of conditions of a first seat within a vehicle and modifying the operation of at least one vehicle safety system in response to the conditions of the seat. Various features and advantages of the invention are set forth in the following claims.

What is claimed is:

1. A system for modifying the operation of one or more safety systems, the system comprising:
a sensor module within a seat and including an acceleration sensor, the sensor module configured to generate an acceleration signal indicative of a condition of the seat;
a control module connected to the sensor module, the control module configured to receive the acceleration signal from the sensor module and generate a control signal in response to the acceleration signal; and
a safety system connected to the control module, the safety system configured to receive the control signal and modify a safety parameter based on the control signal.

2. The system of claim 1, wherein the acceleration sensor is a three-axis accelerometer.

3. The system of claim 1, wherein the control module is further configured to determine a vehicle velocity based on the acceleration signal.

4. The system of claim 1, wherein the safety parameter corresponds to at least one of an activation or deactivation of an airbag.

5. The system of claim 1, wherein the condition of the seat is a seat-back tilt angle.

6. The system of claim 5, wherein the control signal is an occupant classification signal which is based at least in part on the seat-back tilt angle.

7. The system of claim 6, wherein the safety parameter is at least one of an airbag deployment time, an airbag deployment force, and a seat-belt pre-tensioning, the safety parameter being modified based at least in part on the occupant classification signal.

8. A method of modifying the operation of one or more safety systems, the method comprising:
generating an acceleration signal indicative of a condition of a seat;
receiving the acceleration signal at a control module;
generating a control signal in response to the acceleration signal;
receiving the control signal at a safety system; and
modifying a safety parameter based on the control signal.

9. The method of claim 8, wherein the safety parameter corresponds to at least one of an activation or deactivation of an airbag.

10. The method of claim 8, further comprising classifying a vehicle event based at least in part on the acceleration signal.

11. The method of claim 10, wherein the vehicle event is a collision.

12. The method of claim 8, wherein the condition of the seat is a seat-back tilt angle.

13. The method of claim 12, wherein the control signal is an occupant classification signal which is based at least in part on the seat-back tilt angle.

14. The method of claim 13, wherein the safety parameter is at least one of an airbag deployment time, an airbag deployment force, and a seat-belt pre-tensioning, the safety parameter being modified based at least in part on the occupant classification signal.

15. A system for controlling the operation of a safety device within a vehicle, the system comprising:
a acceleration sensor located within a seat-back of a vehicle seat, the acceleration sensor configured to generate a signal indicative of an acceleration of the vehicle seat along an axis;
a control module configured to receive the signal from the acceleration sensor and generate a control signal based on the acceleration of the vehicle seat; and
a safety system configured to receive the control signal and modify a control parameter of the safety device based on the acceleration of the vehicle seat.

16. The system of claim 15, wherein the control module is further configured to determine a vehicle velocity based on the acceleration signal.

17. The system of claim 15, wherein the safety parameter corresponds to at least one of an activation or deactivation of an airbag.

18. The system of claim 15, wherein the control module is further configured to determine a seat-back tilt angle based at least in part on the acceleration signal.

19. The system of claim 18, wherein the control signal is an occupant classification signal which is based at least in part on the seat-back tilt angle.

20. The system of claim 19, wherein the control parameter is at least one of an airbag deployment time, an airbag deployment force, and a seat-belt pre-tensioning, the control parameter being modified based at least in part on the occupant classification signal.
